(19) United States
(12) Patent Application Publication
(10) Pub. No.: US 2026/0183832 A1
(43) Pub. Date: Jul. 2, 2026

(54) Joining Method And Self-Piercing Joining Element

(71) Applicant: Newfrey LLC, New Britain, CT (US)

(72) Inventors: Vadim SARTISSON, Giessen (DE); Christian Reis, Lubebbecke (DE); Orhan Demircioglu, Giessen (DE); Maximilian Stock, Giessen (DE)

(73) Assignee: Newfrey LLC, New Britain, CT (US)

(21) Appl. No.: 19/545,617

(22) Filed: Feb. 20, 2026

Related U.S. Application Data
(63) Continuation of application No. PCT/EP2024/073433, filed on Aug. 21, 2024.

(30) Foreign Application Priority Data
Aug. 22, 2023 (EP) 23192697.3

(51) Int. Cl. B21J 15/02; B21J 15/08; F16B 5/04; F16B 19/04; F16B 19/08

(52) U.S. Cl. CPC B21J 15/025; B21J 15/08; F16B 5/04; F16B 2019/045; F16B 19/086

(57) ABSTRACT

A method for joining components, particularly metal components, via a joining element which is deformed during the joining process, comprising the following steps: coating a joining element with a temperature-stable coating; preheating at least one of at least two components in an area of a joining location to a preheating temperature in the range from 90° C. to 1,400 ° C., preferably by plasma-heating, laser-heating, electric arc heating and/or induction heating, wherein the components are stacked on top of each other; and driving the coated joining element into the stacked components.

### CROSS-REFERENCE TO RELATED APPLICATIONS

This application is a bypass continuation of International Application No. PCT/EP2024/073433, filed on Aug. 21, 2024, which claims priority to European Application No. 23192697.3, filed on Aug. 22, 2023. The entire disclosure of each of the above applications is incorporated herein by reference.

### FIELD

The present disclosure relates to a method for joining components, particularly metal components, via a joining element which is deformed during the joining process, wherein the components are stacked on top of each other and wherein the joining element is driven in an area of a joining location into the stacked components.

Further, the present disclosure relates to a joining element for use in a joining method, wherein the joining element deforms when being used in the joining method. A self-piercing rivet (SPR) is an example of such a joining element, which has a hollow shaft.

### BACKGROUND

This section provides background information related to the present disclosure which is not necessarily prior art.

A SPR is driven by the following procedure. First, an upper component (for example, a high-strength steel plate) and a lower component (for example, an aluminum plate or another steel plate) to be fastened are clamped by a die, and the SPR is held by a fastening tool or by the die and a nose piece of the fastening tool. When the SPR is punched, the shaft of the SPR pierces and penetrates the upper component. When the shaft of the SPR penetrating the upper component enters the lower component and the lower surface of the lower component comes into contact with the bottom of the die, the bottom of the die cavity pushes back the lower component. As a result, the hollow shaft of the SPR receives a reaction force from the lower component and opens in a ring shape in the lower component without fully penetrating the lower component. A mechanical interlock is formed by opening the shaft of the SPR, and the upper component and the lower component are mechanically fastened.

The number of components to be fastened may be two, three or more. For example, in the case of three components, at least the uppermost component is fully penetrated, and the lowermost component is not fully penetrated. In the production of automobiles, an adhesive is often applied between the components to be fastened in order to improve the performance with regard to load bearing capacity, crash stability, improved corrosion resistance, and noise, vibration, harshness (NVH).

Prior art document DE 10 2014 000 623 B4 discloses a self-piercing rivet which has a corrosion protection layer which is covered by a top layer which allows to adjust setting characteristics as friction and material flow.

For the joining of new materials, existing SPR joining systems are sometimes not satisfactory.

### SUMMARY

This section provides a general summary of the disclosure, and is not a comprehensive disclosure of its full scope or all of its features.

It is an object of the present disclosure to provide an improved method for joining components and an improved joining element.

The above object is achieved by a method for joining components, particularly metal components, via a joining element which is deformed during the joining process, comprising the following steps: coating a joining element with a temperature-stable coating, which preferably is temperature-stable by having a melting point of higher than 250 degrees Celsius (° C.) and preferably lower than 1455° C., further preferably lower than 1400° C., further preferably lower than 1200° C., and even more preferably lower than 950° C.; preheating at least one of at least two components in an area of a joining location to a preheating temperature in the range from 90° C. to 1,400° C., preferably by plasma-heating, laser-heating, electric arc heating and/or induction heating, wherein the components are stacked on top of each other; and driving the coated joining element into the stacked components.

Further, the above object is solved by a joining element for use in a joining method, particularly in a joining method as defined above, the joining element having a head and a shaft, wherein the joining element is at least partially coated with a temperature-stable coating, and is preferably configured to be deformed during the joining method.

For the joining of new materials it has been proven to be advantageous to equip the mechanical joining process with integrated preheating of the components to be joined (so-called thermally assisted mechanical joining processes). Thereby the components to be joined are preheated via plasma, laser, induction, electric arc, or similar, and—subsequently or slightly overlapping/parallelized—a joining element is driven into the components to be joined. During the joining process, the joining location is still at a high temperature (at least 90° C., up to 1,400 ° C.). The temperature achieved should be lower than the melting temperature of the component.

Due to the high temperature of the joining point, the coating of prior art joining elements can melt locally during the setting process and, in combination with its deformation, can lead to crack formation in the prior art joining element during the process. Such cracking can occur due to liquid metal embrittlement (LME)/liquid metal induced stress corrosion cracking, local softening of the joining element material, but also due to other effects such as the local change in friction coefficient.

The joining element of the present disclosure, on the other hand, has a temperature-stable coating, which preferably is temperature-stable by having a melting point of higher than 250° C. and preferably lower than 1455° C., further preferably lower than 1400° C., further preferably lower than 1200° C., and even more preferably lower than 950° C. The coating, however, need not be fully temperature-stable for the higher and highest temperatures of the above pre-heating range of 90° C. to 1,400° C. In fact, the pre-heating step includes preheating a component to a rather high temperature, which is less than the melting temperature of the component. The pre-heating step preferably is stopped before the coated joining element is driven into the stacked components. Therefore, during the driving step, and preferably even before the start of the driving step, the temperature of the component decreases. The decrease can be quite rapid. The pre-heating range of 90° C. to 1400° C. is meant to cover a temperature range starting from the highest (maximum) pre-heating temperature of a component to a pre-heating temperature which has decreased during the driving step. As the pre-heating step is preferably stopped before the driving step begins, the coated joining element is never subjected, or only very briefly subjected, to the highest (maximum) pre-heating temperature.

In addition, the coating is preferably not corrosive for the material of the joining element, preferably at least in its liquid phase, or both in its solid phase as well as in its liquid phase. Further, the coating is preferably deformation-stable and is preferably provided with an adjusted or optimized coefficient of friction. The optimized coefficient of friction can be adjusted by the use of a top coat with integrated lubricants, for example.

The coating is preferably applied by an alkaline process, e.g. by electroplating, or in an immersion bath, or chemically. Other coating processes are possible. The joining element is preferably made from a unitary metal material, particularly steel.

The joining components can be stacked directly on top of each other, wherein it is preferred if they lie on each other without any gap. However, it is preferred if the components are stacked on top of each other, wherein an adhesive is provided therebetween.

During the preheating, at least one of the two components is heated, wherein the heat is typically conducted to the other component and/or to the adhesive. Typically, the uppermost component of the stacked components is pre-heated in an area of the joining location. In other embodiments, however, it is possible to apply the heat to the lowermost component of the stacked components in the pre-heating step. In case that the heat is applied to the lowermost component while the joining element is driven into the stacked components from above (into the uppermost component first), the joining element is subjected to the higher temperature at a later stage and may have a larger deformation in its lower (deeper) portion. On the other hand, if the pre-heating step is applied to the same component into which the joining element is driven, the joining element is subjected to the higher temperature at an earlier stage, but has less deformation in an upper portion thereof.

The components are preferably sheets, particularly metal sheets or plates, but may also be molded parts, cast parts, or extruded profiles.

The joining element is preferably not pre-heated before the joining process, but is provided at room temperature. It is to be understood that the joining element will receive heat from the preheated component(s) during the joining process.

The coated joining element is driven into the stacked components in the area of the joining location.

The combination of deforming joining elements with a temperature-stable coating for thermally assisted mechanical joining processes has not been demonstrated so far.

The coating is preferably a multilayer composite coating system, but can also be a thermally-stable one-layer system with added anti-friction agent. Also, a further passivation layer can be provided.

Preferably, the coating is provided such that no melting of the coating occurs in the head area when inserting the rivet, and thus provides an improved corrosion protection. Preferably, the coating on the shaft does not melt either during the joining process.

Particularly, the disclosed joining method allows joining elements to be set without cracking during the thermally assisted mechanical joining processes. Prior art rivets with zinc-tin coatings, on the other hand, may suffer from a large number of cracks in such heat-superimposed processes. It goes without saying that such cracks could also be avoided due to an adjustment of the geometry or the material of the rivet, but such changes lead to other disadvantages, such as increased costs, reduction of the application limits or increase of the joining forces.

The object is therefore achieved in full.

In a preferred embodiment, the pre-heating step includes applying heat to one of the uppermost or the lowermost component up to a maximum pre-heating temperature, which is higher than 30 percent (%) of the melting temperature of the respective component.

With this maximum pre-heating temperature, the subsequent driving step can be conducted in a particularly efficient and fault-free manner.

Preferably, the maximum pre-heating temperature is higher than 35%, further preferred higher than 40%, further preferred higher than 75%, particularly higher than 80% of the melting temperature of the respective component, in a preferred embodiment higher than 85% thereof. It is most preferable if the maximum pre-heating temperature is higher than 88% of the melting temperature of the respective component.

Further, it is preferred if the maximum pre-heating temperature is lower than 98%, particularly lower than 96%, and preferably lower than 94% of the melting temperature of the respective component.

In a preferred embodiment, the coating comprises a base coating which has a high thermal stability, and a friction control coating which is applied on the base coating.

Such a multi-layer coating system has proven to be particularly advantageous in thermally assisted mechanical joining processes. The friction control coating controls the friction value, but also improves corrosion resistance, chemical resistance against acids, and acts as another isolation layer. Applying the friction control coating on the base coating includes applying the friction control coating on a passivation layer provided on top of the base coating.

Here, it is preferred if the base coating is made of a zinc-based coating or a nickel-based coating or a copper-based coating, and is in particular made of at least one material which is selected from the group which comprises: zinc (Zn), a Zn alloy, zinc nickel (ZnNi), nickel (Ni), a Ni alloy, nickel phosphide (NiP), nickel tungsten (NiW), copper (Cu), a Cu alloy, copper nickel (CuNi), zinc flake, etc.

Such coating systems have a high abrasion resistance and have melting temperatures of above 250° C. Preferably, the melting temperature of the coating is higher than 400° C. (e.g. for Zn), particularly higher than 700° C. The melting temperature may be lower than 1455° C., further preferably lower than 1400° C., further preferably lower than 1200° C., and even more preferably may be lower than 950° C. Further, the mentioned coating systems provide good corrosion resistance.

In addition, it is preferred if the friction control coating is an organic coating, particularly an organic coating containing aluminum. Particularly, it is preferred if the friction control coating is made of at least one material which is selected from the group which comprises: Magni B18, Torque'N'Tension, Microgleit® DF 921, etc.

Magni B18 is a well-known top coat, which is preferably applied via an immersion process, a spin coating process, a spray coating process, and is subsequently dried/fired, e.g. for 15 min to 25 min at 190° C. to 230° C. The other above-listed coating materials of other manufacturers are also well known.

Further, it is preferred if the friction control coating has a friction coefficient in a range from 0.07 to 0.19, particularly in a range from 0.08 to 0.18, preferably in a range from 0.12 to 0.18 or in a range from 0.08 to 0.13.

On the other hand, it is preferred if the base coating has a thickness in a range from 3 micrometers (μm) to 15 μm, preferably in a range from 3 μm to 12 μm, particularly from 5 μm to 10 μm.

A base coating is preferably (i) a zinc-based coating which includes preferably 8% to 20% nickel, particularly 12% to 16% nickel, wherein the rest is preferably Zn, or (ii) a nickel-based coating which includes preferably 1% to 15% phosphorous or which includes preferably 30% to 35% tungsten, wherein the rest is preferably Ni, or (iii) a copper-based coating.

Further, it is particularly preferred if the base coating is provided with a passivation layer before the friction control layer is applied.

The passivation layer provided on top of the base coating by a passivation process has a thickness which is preferably in a range from 50 nanometers (nm) to 400 nm.

The passivation process is preferably a chemical process for reducing the reactivity of this layer and for delaying white rust formation or corrosion of the base coating.

Further, it is preferred if after the passivation process, the joining element is baked as a post heat treatment, e.g. for hydrogen de-embrittlement. The baking treatment may start up to 4 hours after the passivation process, at a temperature of e.g. 190° C. to 230° C., and stops at least 6 hours and up to 10 hours later.

Further, it is preferred if the friction control coating has a thickness in a range from 1 μm to 6 μm, particularly in a range from 2 μm to 4 μm.

As described above, the coating of the joining element is preferably a multi-layer coating as described above.

In another preferred embodiment, the coating is a one-layer system which preferably includes an anti-friction component as an addition.

Here, the coating system can be a zinc flake coating to which is added an anti-friction agent/component. The one-layer system may, however, be realized without any additional agent, and may be a PURE Ni coating.

Further, the joining element is preferably a punch rivet, particularly a self-piercing rivet (SPR).

Further, it is preferred if the joining element has a Vickers hardness in a range from 220±30 Vickers Pyramid Number (HV) 10 to 590±30 HV10, particularly in a range from 380±30 HV10 to 510±30 HV10.

In general, the joining element can have all typical hardnesses, from below H0 to H6, particularly from H2 to H4.

In general, the step of driving the coated joining element into the stacked components may start before the pre-heating step has ended.

In a preferred embodiment, the step of driving the coated joining element into the stacked components is started at least 0.05 seconds(s) after the pre-heating step has ended, preferably in a range from 0.05 s to 0.8 s after the pre-heating step has ended.

The start of the step of driving is understood to be the moment, where the joining element contacts the upper side of the stacked components and begins to penetrate the stack.

In a preferred embodiment, the driving step starts at least 0.1 s, preferably 0.15 s, and particularly at least 0.2 s after the pre-heating step has ended.

Further, it is preferred if the driving step is started at the latest 1.5 s after the pre-heating step has ended, preferably at the latest 1 s after the pre-heating step has ended, and particularly preferred at the latest 0.8 s after the pre-heating step has ended.

The at least two components of the stacked components include preferably a first component, which may be an uppermost component, which is made of steel, particularly a high-strength steel having a strength (particularly ultimate tensile strength) in the range from 1000 megapascal (MPa) to 2100 MPa. More particularly, the first component is facing the pre-heating device. In other words, the first component is closer to the pre-heating device than the other(s) components. The high-strength steel preferably has a constant thickness in a range from 0.8 millimeters (mm) to 3.0 mm. Further, it is preferred if the steel is made of one of 22MnB5 and DP1000. The 22MnB5 is preferably provided with a constant thickness in a range from 1.0 mm to 2.3 mm. The DP 1000 is preferably provided with a constant thickness in a range from 1.0 mm to 3.0 mm, particularly in a range from 1.2 mm to 3.0 mm.

In another preferred embodiment, the at least two components include a second component, which may be a lowermost component which is made of an aluminum (Al) alloy, particularly one of AlMg_{4<x<5}Mn_{0.3<y<0.5} and AlMg_{2<x<5}. The Al alloy preferably has a constant thickness in a range from 1 mm to 4 mm. The first mentioned specific aluminum alloy is preferably provided with a constant thickness in a range from 1 mm to 3 mm. The second-mentioned aluminum alloy is preferably provided with a constant thickness in a range from 2 mm to 4 mm.

The location of the upper component made of steel and of the lower component made of an Al alloy may be exchanged, so that the joining element is driven into the stack from the surface of an Al alloy component.

Further, it is preferred if the pre-heating step includes heating the joining location area up to a maximum pre-heating temperature, and stopping or ramping down the heating thereafter.

As discussed above, the maximum pre-heating temperature is preferably higher than 30% of the melting temperature of the component which is pre-heated, and preferably less than 98% of the melting temperature thereof.

Further, in a preferred embodiment, the step of driving the coated joining element into the stacked component starts at a temperature of the joining location area which is less than the maximum pre-heating temperature and higher than 30% of the maximum pre-heating temperature. Preferably, the driving step starts at a temperature of the joining location area of higher than 40%, and preferably higher than 50% of the maximum pre-heating temperature.

Again, the start of the driving step coincides with the time at which the joining element contacts the stack and begins to penetrate the stack.

Further, it is preferred if the step of providing the coated joining element into the stacked component ends at a temperature of the joining location area, which is higher than the temperature of the environment (typically higher than 20° C.), and less than 85% of the maximum pre-heating temperature.

In other words, the driving step ends well before the joining location area has completely cooled down to the temperature of the environment. On the other hand, it is preferred if the temperature has already decreased to a certain amount.

Preferably, the driving step ends at a temperature of the joining location area which is less than 60%, preferably less than 40%, and in particular less than 30% of the maximum pre-heating temperature.

Further, it is preferred if the driving step ends at a temperature of the joining location area which is higher than 5% of the maximum pre-heating temperature, preferably higher than 10% of the maximum pre-heating temperature.

The end of the driving step is defined to be the moment at which the joining element has reached its final position within the stack (e.g. head rests on upper surface), so that the tool for the setting process can be retracted. The definition is applicable although it is to be understood that a full driving cycle may end only after the tool (punch) and optionally a nose piece/holder have been returned to their respective end positions.

The above temperature limits contribute to establishing a joining process where the heat decreases continuously during the driving step, wherein the temperature of the joining location area is preferably rather high at the beginning of the driving step, and is preferably already significantly lower at the end of the driving step.

In the self-piercing rivet which is used in the joining method, the coating is provided preferably on its entire surface, although it is generally possible to provide the coating only in certain areas of the surface. Particularly, it is preferred if at least the outer circumference of the shaft and the head top surface are coated, because the friction coefficient is of particular relevance in the area of the shaft of the rivet, and because the head top surface needs to be coated in order to provide the necessary corrosion resistance. Preferably, a head underside radius and/or an annular cutting edge of the shaft and/or an annular radial end surface of the shaft are coated as well.

In general, it is possible that the coating of the joining element is partially abraded during the driving step. The abrasive wear may be different, depending on the temperature to which it is subjected.

It will be understood that the aforementioned features and to be described hereinafter cannot only be used in the respectively given combination, but also in different combinations or independently, without departing from the scope of the present disclosure.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic flowchart of a method for joining components;

FIG. 2 is a schematic sectional view of a self-piercing rivet;

FIG. 2a is a detail IIa of FIG. 2;

FIG. 3a is a sectional view of a joint produced by the disclosed method for joining components using a self-piercing rivet;

FIG. 3b is a detail of FIG. 3a;

FIG. 4a is a sectional view comparable to FIG. 3a of a comparison example;

FIG. 4b is a detail of FIG. 4a;

FIG. 5a is a sectional view comparable to FIG. 3a of another comparison example;

FIG. 5b is a detail of FIG. 5a;

FIG. 6 is a diagram of temperature versus time, showing the progression of a joining method of the present disclosure;

FIG. 7 is a diagram of temperature versus time of a pre-heating step, showing temperatures on an upper side, a lower side and a central portion of a component stack;

FIG. 8 shows bottom views of self-piercing joining elements after being set in a stack of material by joining methods with pre-heating and the use of non-coated joining elements; and

FIG. 9 shows a bottom view of self-piercing joining element after being set in a stack of material by a joining method of the present disclosure.

In the drawings, reference numbers may be reused to identify similar and/or identical elements.

### DETAILED DESCRIPTION

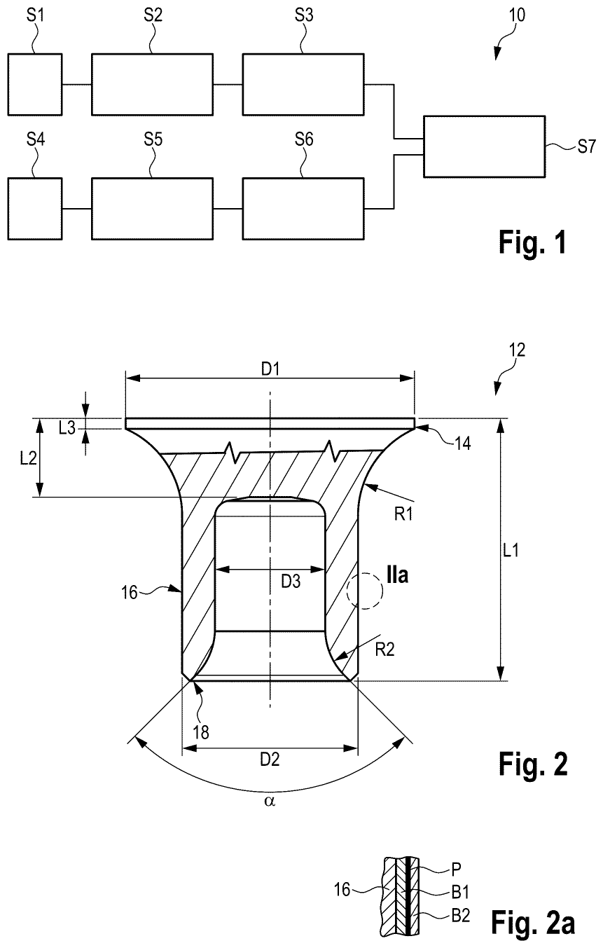

In FIG. 1, a method for joining components is shown in a schematic flowchart 10.

The flowchart 10 includes a step S1 in which at least two components are provided. The components are preferably metal components, particularly sheet components.

The first, upper component is a metal sheet, preferably a steel sheet or an aluminum sheet or a magnesium sheet, for example made of Usibor® 2000.

The second component is a metal sheet, which can be made of EN AW-5182.

In a step S2, the two components are inserted into a joining tool (or the joining tool is moved to the components), particularly a self-piercing riveting tool, where they are stacked on top of each other, preferably with an adhesive therebetween.

In a step S3, at least one of the components is heated in an area of a joining location to a temperature in the range from 90° C. to 1,400° C., preferably by plasma-heating, laser-heating, electric arc heating and/or induction heating. The preheating is done while the components are stacked on top of each other. The preheating step includes applying heat to one of the uppermost or the lowermost component up to a maximum preheating temperature which is preferably higher than 30% of the melting temperature of the respective component.

The temperatures of the components to be joined, in general, relate to the temperatures as measured in the middle of the component stack. Therefore, the temperature at the surface which is heated may be higher than the temperature mentioned. The reason for defining the temperatures in this way is that a direct measurement of the temperature of the surface is in some cases not possible, particularly if the surface is heated by plasma-heating. The measurement could also be made directly under the heating area on component stack.

The joining tool typically has a lower die and has a punch tool for driving joining elements such as an SPR into the stacked components. The tool typically has a nose piece (holder). The component stack is typically arranged in the tool such that a joining area thereof is placed upon the die and below the nose piece, wherein, subsequently, the component stack is typically clamped between the nose piece and the die before the joining process starts. The clamping step may be performed before or after the preheating step.

On the other hand, in a step S4, a joining element such as a self-piercing rivet is provided. In a step S5, the joining element is coated. Particularly, the joining element is first coated with a base coating, wherein the base coating is preferably passivated, and is subsequently coated with a friction control coating.

As an alternative, the joining element can be coated with an improved one-layer coating in step S5.

It is to be understood that the joining component is not coated at the same time as the components are stacked. Rather, the joining element is provided such that steps S4 and S5 are conducted well before the joining process, and well before steps S1 to S3.

In step S6, a coated joining element is inserted into the joining tool.

In a step S7, the coated joining element is driven into the preheated stacked components, so as to produce a self-pierced rivet joint.

The joining element is preferably a self-piercing rivet but could be any other type of joining element which is deformed during the joining process. A self-piercing rivet that can be used for the above joining method 10 is shown in FIGS. 2, 2a.

A self-piercing rivet (SPR) 12 has a head 14 and a hollow shaft 16. The hollow shaft 16 has an end which is opposite to the head 14 and which forms an annular cutting edge 18.

The material of the self-piercing rivet can be 37MnB4, for example. The material of the joining element has typically a hardness in a range from 220±30 HV10 to 590±30 HV10, particularly in a range from 380±30 HV 10 to 510±30HV10, measured as a Vickers hardness. The hardness may be in a range from below H0 to H6.

Self-piercing rivets such as the rivet 12 shown in FIG. 2 can have a variety of different dimensions, depending on the respective application. The following examples of dimensions of the self-piercing rivet 12 shown in FIG. 2 are therefore considered to be examples only and are not intended to limit the rivet to these dimensions.

The self-piercing rivet 12 has an axial length L1 of, for example, 5.0 mm. The head 14 has an outer diameter D1 of, for example, 5.5 mm or 7.75 mm.

The shaft 16 has an outer diameter D2 of, for example, 3.35 mm or 5.3 mm or 5.5 mm.

An inner diameter D3 of the shaft 16 is smaller than the outer diameter D2.

The head 14 has an axial length L2 of, for example, 1.0 mm. The head has a crown with a constant outer diameter (the diameter D1), which has an axial crown length L3 of, for example, 0.2 mm.

The underside of the head reduces from the outer diameter D1 to the outer diameter D2 through a radius R1, which is, for example, 1.8 mm.

The shaft 16, in the area of its annular cutting edge 18, has a shaft inner chamfer, which is designed by a second radius R2 of, for example, 1.3 mm.

An opening angle α of the shaft inner chamfer is preferably 90°.

If the self-piercing rivet 12 is driven into the stacked components, it pierces with its annular cutting edge 18 into the upper component and, during the further joining process, the shaft fully penetrates the upper component. When the shaft enters the lower component, the lower surface of the lower component comes into contact with the bottom of the die, so as to create a reaction force. As a result, the hollow shaft of the rivet opens in a ring shape in the lower component without penetrating the lower component.

This basic principle is the same for any self-piercing rivet, wherein, as mentioned above, the dimensions thereof may vary. The joining element does not necessarily have to have a distinct head; rather, the outer diameter thereof may be essentially constant over its length. Also, the joining element need not fully penetrate the upper component.

Typically, the rivets used in such process are provided in the prior art with a coating which can be tin zinc, for example. Such a coating is typically sufficient when using the rivet in normal self-piercing rivet processes.

Further, the prior art rivet is typically provided with a lubricant before being used in the joining process.

Another typical prior art coating of such rivets is Tri-ALLOY which is typically a composition of Al, tin (Sn) and Zn.

On the other hand, according to the present disclosure, the rivet 12 is provided with a temperature-stable coating, which is preferably a multi-layer coating as shown in FIG. 2a.

Particularly, the rivet 12 is coated first with a base coating B1 which has a high thermal stability, which has a melting temperature which is higher than 250° C. Subsequently, the rivet 12 is coated with a friction control coating B2 which, in relation to the component stack, provides an optimized friction coefficient that is lower than the friction coefficient of a rivet not provided with the friction control coating B2.

The base coating B1 is preferably made of a zinc-based coating or a nickel-based coating or a copper-based coating, and is in particular made of at least one material which is selected from the group which comprises: Zn, a Zn alloy, ZnNi, Ni, a Ni alloy, NiP, NiW, Cu, a Cu alloy, CuNi, zinc flake, etc. The base coating is preferably (i) a zinc-based coating which includes preferably 8% to 20% nickel, particularly 12% to 16% nickel or (ii) a nickel-based coating which includes preferably 1% to 15% phosphorous or which includes preferably 30% to 35% tungsten, or (iii) a copper-based coating.

In case that the base coating comprises mainly Ni, it may be preferred if a thin copper layer acting as a primer/bonding agent is provided on the rivet 12 before the base coating is applied. In this case, the base coating is Cu+Ni.

The base coating B1 is preferably provided with a thickness in a range from 3 μm to 12 μm, particularly in a range from 5 μm to 10 μm. The base coating B1 preferably includes Zinc (80% to 92%) and 8% to 20% nickel, particularly Zinc (84% to 90%) and 10% to 16% nickel. Such a ZnNi based coatings typically have a melting temperature of 750° C. to 800° C.

On the other hand, the friction control coating B2 is preferably an organic coating, particularly an organic coating containing aluminum. Preferably, the friction control coating B2 is made of at least one material which is selected from the group which comprises: Magni B18, Torque'N'Tension, Microgleit® DF 921, etc.

Magni B18 is a top coat produced by the Magni Group, Inc. Torque'N'Tension is a top coat produced by MacDermid Enthone Industrial Solutions. Microgleit® DF 921 is a micro-PE dry-sliding film produced by Microgleit® Tribology Solutions.

Preferably, the base coating B1 is passivated so as to produce a passivation layer P before the friction control coating B2 is applied.

The passivation is preferably a chemical passivation using a passivation solution.

Passivation solutions which are suitable for this purpose consist mainly of complexed chromium (III) ions as well as cobalt, nitrate and complex ions (e.g. fluorides or organic acids).

After the passivation process, the rivet 12 is preferably baked (heat post-treatment for hydrogen de-embrittlement).

The friction control coating has, as mentioned above, preferably a friction coefficient in a range from 0.07 to 0.19, particularly in a range from 0.08 to 0.18, preferably in a range from 0.08 to 0.13.

Further, the friction control coating has a thickness which is preferably in a range from 1 μm to 6 μm, particularly in a range from 2 μm to 4 μm.

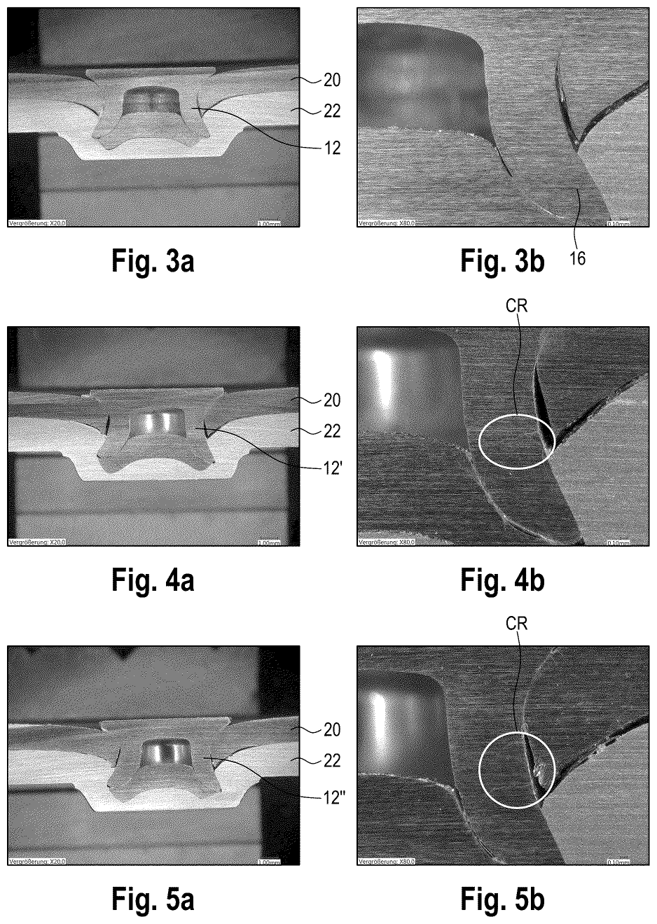

FIG. 3a and FIG. 3b show an example of a joint which is produced with a rivet 12 which was produced from 37MnB4 with a hardness H4.

Further, the lower metal component was made of AlMg4.5Mn0.4, with a thickness of 2 mm. The upper component 20 was made of Usibor® 2000 (Cr1900T-MB-DS (according to Draft VDA 239-500 (May 2021)). The joining force was in the range between 55 kilonewton (kN) and 60 kN.

The rivet 12, according to FIG. 3a, has pierced the upper component 20 and has entered the lower component 22 without piercing through the lower component 22. As can be seen in the detail of FIG. 3b, the shaft 16 of the rivet 12 has deformed without any cracks.

The crack-free setting of the rivet 12 can be attributed to the coating of the rivet 12 which was in this case a ZnNi base coating B1, a passivation layer P as described above, and a Magni B18 top coat with integrated lubricant.

On the other hand, FIG. 4a and FIG. 4b show a comparison example, where the same components 20, 22 have been used and a rivet 12′ which was coated with Tri-ALLOY instead.

As can be seen in FIG. 4b, cracks CR have developed in the shaft 16.

In FIG. 5a and FIG. 5b, another comparison example is shown.

Here, the components 20, 22 are identical to the ones of FIGS. 3a, 3b. The rivet 12′′ has been coated with a mechanical SnZn coating and a lubricant. As is shown in FIG. 5B, in this case as well cracks CR may occur in the shaft 16.

Therefore, it has been proven that the coating as shown in FIG. 2a and described above, is superior to the classic coatings of self-piercing rivets if the self-piercing rivet is used in a thermally assisted mechanical joining process where the joining location is preheated to a temperature in the range from 90° C. to 1,400° C., preferably to a maximum preheating temperature which is higher than 30% of the melting temperature of the respective component.

As an alternative to the coating of FIG. 2a, which consists essentially of three layers B1, P, B2, a one-layer system can be applied to the rivet 12 as well, which includes an anti-friction component as an additional agent.

For example, the one-layer system can be a zinc flake coating which includes an anti-friction component.

Examples for such one-layer systems are GEOMET 500 as produced by NOF METAL COATINGS EUROPE, which provides a controlled friction value between 0.12 and 0.18.

Another example of such a one-layer system is DELTA-Protekt KL 105, which is manufactured by Dörken Coatings. This coating as well provides a defined coefficient of friction window between 0.12 and 0.18.

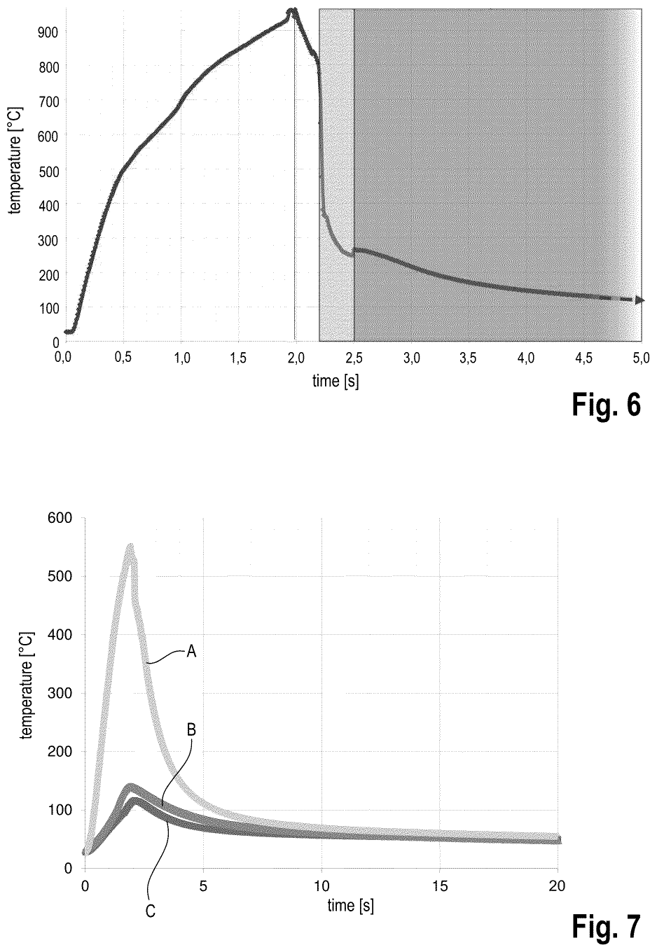

FIG. 6 shows a diagram of temperature versus time for a joining method of the present disclosure.

The process starts with pre-heating at least one of at least two components which form a component stack, in the present case starting shortly after a time 0.0 s up to a maximum pre-heating temperature at time 2.0 s of well above 900° C. At this time, the pre-heating step is stopped. The step of driving a coated joining element into the stacked component starts after a certain delay of at least 0.05 s and not more than 1.5 s. In the present case, the delay is approximately 0.3 s. After the delay, the pre-heating temperature has decreased by more than 10%, to approximately 800° C. in the present example.

Preferably, the time delay between stopping the pre-heating step and starting the driving step depends on the measured temperature. For example, a punching step for moving the joining element from a basic position (where the joining element is distant from the stack) to the position where it contacts the stack (start of driving), may be started as soon as the maximum pre-heating temperature is reached. Moving the joining element from the basic position to the driving start position may create or contribute to the time delay. In another example, the driving step may be started at a desired driving temperature which can be calculated as follows:

Driving step start temperature=(0.95 to 0.8)*maximum pre-heating temperature

When driving the joining element into the component stack, which starts in FIG. 6 at a time in a range from approximately 2.2 s to 2.5 s a temperature is preferably measured at a central part of the component stack, as is the case in FIG. 6, or at its underside. (As mentioned above, a direct measurement, especially when using plasma pre-heating is not reasonably possible).

The diagram of FIG. 6 is based on an exemplary embodiment of joining a stack of a lower sheet of EN AW-5182 with a thickness of 2.0 mm and an upper sheet of 22MnB5+AS (PH) in a thickness of 1.5 mm. The upper surface of the upper sheet is preheated by a plasma-heating process in the area of the joining location. The preheating step includes heating to a maximum pre-heating temperature within a plasma heating time (using a plasma heating apparatus) of approximately 1.7 s, which leads to a maximum temperature at 2.0 s of approximately 960° C.

It is to be noted that the temperature is not measured at the upper surface of the upper sheet. Instead, it is measured in a central part of the component stack between the upper sheet and the lower sheet. As the pre-heating using the plasma heating apparatus, however, is applied at the upper surface of the upper sheet, the maximum pre-heating temperature at the upper surface is higher than the temperatures shown in FIG. 6. The amount by which the upper surface temperature is higher than the temperatures shown in FIG. 6, can be estimated. This estimation can be used to avoid heating to a measured temperature which would lead to an upper surface temperature higher than the melting temperature of the component. For example, the above-mentioned 960° C. corresponds to an upper surface temperature of higher than 1000° C. but still lower than the melting temperature of the component. It is to be understood that, depending on the temperature of the environment and the thickness of the sheets, the temperature of the surface of the upper sheet (or the closest sheet to the pre-heating device) may decrease more quickly than the temperature inside the sheet.

FIG. 7 shows a comparison of temperatures of temperature profiles measured at different locations of a temperature stack, where the upper sheet is DP 1000 at 1.8 mm and wherein the lower sheet is AlMg3 at 3.0 mm.

A maximum temperature at the underside of the upper sheet (i.e. between the two sheets) is in the present case 550° C. This is shown at A.

On the other hand, the measurement at the lower side of the lower sheet is shown at C. Here, the maximum temperature is about 120° C. The curve B shows a measurement in a central part (measured in the thickness direction) of the lower sheet, with a maximum temperature of about 150° C.

One can see that it is possible to derive from a measurement at a lower or middle part of the component stack the temperature at the heated surface of the stack, which is relevant for calculating the maximum pre-heating temperature which should in any case be lower than the melting temperature of the component to which heat is applied. As discussed above, feature of the maximum pre-heating temperature being preferably less than 98%, preferably less than 95% of the melting temperature of the material of the component which is heated, is to be understood as follows: The maximum pre-heating temperature is chosen such that the maximum temperature of the component (which could be the temperature at the surface to which the heating is applied) is less than 98%, preferably less than 95% of the melting temperature of the material.

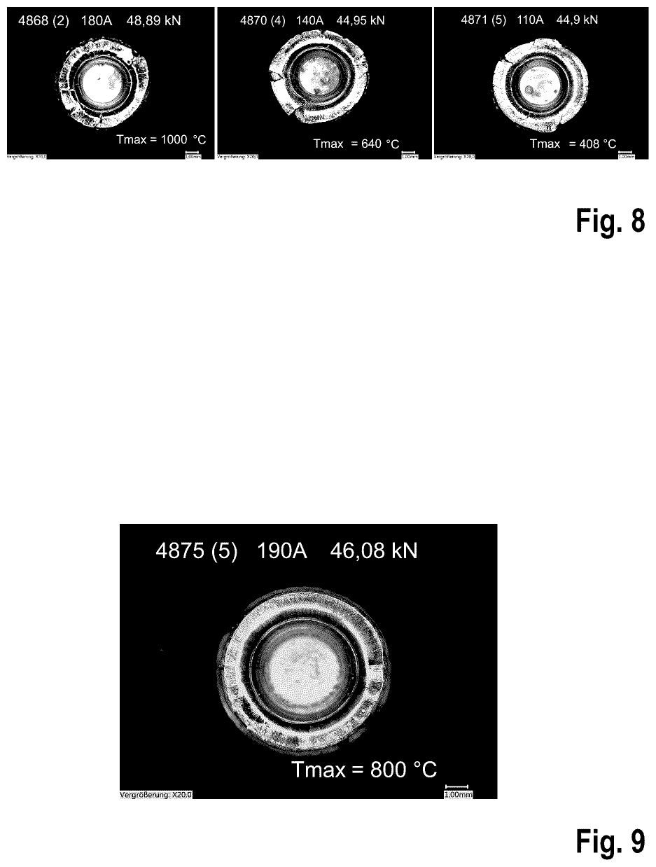

FIG. 8 shows three different joints which have been produced by a joining method which corresponds to the joining method of the present disclosure, wherein, however, the joining element was coated with a standard coating. The stack included an upper sheet made of CR340LA with a thickness of 1.5 mm, and a base sheet made of an aluminum alloy EN AW-5182 at a thickness of 2.0 mm.

In each case, the measurements were made at a punching force in a range from 44.9 kN to 48,89 kN with a C rivet of 5.3×5.5 having a hardness H4 and a standard coating of SnZn, at three different maximum preheating temperatures of 1000° C., 640° C., and 408° C., respectively.

In each of those cases, cracks can be seen, which are less with a reduction of temperature. However, cracks can still be determined when heating to maximum pre-heating temperatures of approximately 400° C.

On the other hand, FIG. 9 shows a joint which has been produced by the method of the present disclosure. No cracks are shown.

The materials of the upper and lower sheets were the same. The rivet was a C rivet 5.3×5.5 with a hardness of H4, and was driven into a stack at a punching force of 46.08 kN.

The rivet was coated with a base coating of a ZnNi alloy at a thickness of 5 to 10 μm in an alkaline process, wherein the alloy contained 12 to 16% Ni.

The base coating of ZnNi was passivated and tempered, and a top coat Magni B18 at a thickness of 2 to 4 μm was applied.

The maximum pre-heating temperature was 800° C., which proves that the application of a coating as presented in the present disclosure, allows pre-heating of the component stack to higher temperatures without producing cracks, so that the overall joining performance can be improved.

Preferred embodiments of the present disclosure are defined in the following clauses:
Clause 1. A method (10) for joining components (20, 22), particularly metal components, via a joining element (12) which is deformed during the joining process, comprising the following steps:
   coating (S5 a joining element (12) with a temperature-stable coating (B1, B2);
   preheating (S3) at least one of at least two components (20, 22) in an area of a joining location to a preheating temperature in the range from 90° C. to 1,400° C., preferably by plasma-heating, laser-heating, electric arc heating and/or induction heating, wherein the components (20, 22) are stacked on top of each other; and
   driving (S7) the coated joining element (12) into the stacked components (20, 22).
Clause 2. The method of Clause 1, wherein the preheating step includes applying heat to one of the uppermost or the lowermost component up to a maximum preheating temperature which is higher than 30% of the melting temperature of the respective component.
Clause 3. The method of Clause 1 or 2, wherein the coating comprises a base coating (B1) which has a high thermal stability and a friction control coating (B2) which is applied on the base coating.
Clause 4. The method of Clause 3, wherein the base coating (B1) is made of a zinc-based coating or a nickel-based coating or a copper-based coating, and is in particular made of at least one material which is selected from the group which comprises: Zn, a Zn alloy, ZnNi, Ni, a Ni alloy, NiP, NiW, Cu, a Cu alloy, CuNi, zinc flake, etc.
Clause 5. The method of Clause 3 or 4, wherein the friction control coating (B2) is an organic coating, particularly an organic coating containing aluminum, and is preferably made of at least one material which is selected from the group which comprises: Magni B18, Torque'N'Tension, Microgleit® DF 921, etc.
Clause 6. The method of any one of Clauses 3 to 5, wherein the friction control coating (B2) has a friction coefficient in a range from 0.07 to 0.19, particularly in a range from 0.08 to 0.18, and preferably in a range from 0.12 to 0.18 or in range from 0.08 to 0.13.
Clause 7. The method of any one of Clauses 3 to 6, wherein the base coating (B1) has a thickness in a range from 3 μm to 15 μm, preferably in a range from 3 μm to 12 μm, particularly in a range from 5 μm to 10 μm.
Clause 8. The method of any one of Clauses 3 to 7, wherein the base coating is preferably (i) a zinc-based coating which includes preferably 8% to 20% nickel, particularly 12% to 16% nickel or (ii) a nickel-based coating which includes preferably 1% to 15% phosphorous or which includes preferably 30% to 35% tungsten, or (iii) a copper-based coating.
Clause 9. The method of any one of Clauses 3 to 8, wherein the base coating (B1), before applying the friction control coating (B2), is passivated and/or is baked.
Clause 10. The method of any one of Clauses 3 to 9, wherein the friction control coating (B2) has a thickness in a range from 1 μm to 6 μm, particularly in a range from 2 μm to 4 μm.
Clause 11. The method of any one of Clauses 3 to 10, wherein a passivation layer provided on top of the base coating (B1) by a passivation process has a thickness in a range from 50 nm to 400 nm.
Clause 12. The method of Clause 1, wherein the coating is a one-layer system which preferably includes an anti-friction component as an addition.
Clause 13. The method of any one of Clauses 1 to 12, wherein the joining element (12) is a punch rivet, particularly a self-piercing rivet.
Clause 14. The method of any one of Clauses 1 to 13, wherein the joining element (12) has a Vickers hardness in a range from 220±30 HV10 to 590±30HV10 , particularly in a range from 380±30 HV10 to 510±30 HV10.
Clause 15. The method of any one of Clauses 1 to 14, wherein
   the step of driving the coated joining element (12) into the stacked components is started at least 0.05 s after the preheating step has ended.
Clause 16. The method of any one of Clauses 1 to 15, wherein the at least two components include a first component which is made of steel, particularly a steel having a strength in the range from 1000 MPa to 2100 MPa, and is preferably made of one of 22MnB5 and DP1000.
Clause 17. The method of any one of Clauses 1 to 16, wherein the at least two components include a second component which is made of an Al alloy, particularly one of AlMg_{4<x<5}Mn_{0.3<y<0.5} and AlMg_{2<x<5}.
Clause 18. The method of any one of Clauses 1 to 17, wherein the preheating step includes heating the joining location area up to a maximum preheating temperature, and stopping or ramping down the heating thereafter.
Clause 19. The method of Clause 18, wherein the step of driving the coated joining element (12) into the stacked components starts at a temperature of the joining location area, which is less than the maximum preheating temperature and higher than 30% of the maximum preheating temperature.
Clause 20. The method of Clause 18 or 19, wherein the step of driving the coated joining element (12) into the stacked components ends at a temperature of the joining location area, which is higher than the temperature of the environment and less than 85% of the maximum preheating temperature.
Clause 21. The use of a joining element (12) which has a coating (B1, B2) providing a high thermal stability and an optimized friction coefficient, in a heat-superimposed mechanical joining process, in particular in a joining method (10) of any one of Clauses 1 to 20.
Clause 22. Self-piercing joining element (12) for use in a joining method, particularly a joining method (10) of any one of Clauses 1 to 20, wherein the self-piercing joining element (12) is at least partially coated with a thermally-stable coating.
Clause 23. Self-piercing joining element of Clause 22, wherein the coating includes a base coating (B1) which has a high thermal stability, and a friction control coating (B2) which is applied on the base coating (B1).

### REFERENCE NUMERALS

10 joining method
12 joining element
14 head
16 hollow shaft
18 annular cutting edge
20 upper component
22 lower component
S1-S7 method steps
B1 base coating
B2 friction control coating
P passivation layer
L1 joining element length
L2 head length
L3 crown length
D1 head diameter
D2 shaft outer diameter
D3 shaft inner diameter
R1 head underside radius
R2 shaft inner chamfer radius
α chamfer angle
CR cracks in shaft

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for joining components via a self-piercing joining element which is deformed during a joining process, the method comprising:
coating a self-piercing joining element with a coating which has a melting temperature;
preheating at least one of at least two components in an area of a joining location to a preheating temperature in a range from 90 degrees Celsius (° C.) to 1,400° C., wherein the components are stacked on top of each other; and
driving the coated self-piercing joining element into the stacked components,
wherein the coating is configured to be temperature-stable during the step of driving the coated self-piercing joining element into the stacked components,
wherein the preheating temperature is lower than the melting temperature of the coating,
wherein the coating comprises a base coating having a high thermal stability and a friction control coating applied on the base coating, the friction control coating being a top coat with integrated lubricants so as to provide for an optimized coefficient of friction, and
wherein the base coating, before applying the friction control coating, is passivated to provide a passivation layer on top of the base coating, the passivation layer having a thickness in a range from 50 nanometers (nm) to 400 nm.

2. The method of claim 1, wherein the base coating is made of one of a zinc-based coating, a nickel-based coating, or a copper-based coating.

3. The method of claim 2, wherein the base coating is made of at least one material selected from the group consisting of: zinc (Zn), a Zn alloy, zinc nickel (ZnNi), nickel (Ni), a Ni alloy, nickel phosphide (NiP), nickel tungsten (NiW), copper (Cu), a Cu alloy, copper nickel (CuNi), and zinc flake.

4. The method of claim 2, wherein the base coating is a zinc-based coating which includes 8% to 20% nickel.

5. The method of claim 2, wherein the base coating is a nickel-based coating which includes one of 1% to 15% phosphorous or 30% to 35% tungsten.

6. The method of claim 1, wherein the friction control coating has a friction coefficient in a range from 0.07 to 0.19.

7. The method of claim 1, wherein the base coating has a thickness in a range from 3 micrometer (μm) to 15 μm.

8. The method of claim 1, wherein the base coating, before applying the friction control coating, is baked.

9. The method of claim 1, wherein the friction control coating has a thickness in a range from 1 μm to 6 μm.

10. The method of claim 1, wherein the joining element is a punch rivet.

11. The method of claim 1, wherein the joining element has a Vickers hardness in a range from 220±30 Vickers Pyramid Number (HV) 10 to 590±30 HV10.

12. The method of claim 1, wherein the at least two components include a first component which is made of steel having a strength in the range from 1000 megapascal (MPa) to 2100 MPa.

13. The method of claim 12, wherein the at least two components include a second component which is made of an aluminum alloy.

14. The method of claim 1, wherein the preheating step includes heating the joining location area up to a maximum preheating temperature, and stopping or ramping down the heating thereafter.

15. The method of claim 14, wherein the step of driving the coated joining element into the stacked components starts at a temperature of the joining location area, which is less than the maximum preheating temperature and higher than 30% of the maximum preheating temperature.

16. The method of claim 15, wherein the step of driving the coated joining element into the stacked components ends at a temperature of the joining location area, which is higher than a temperature of the environment and less than 85% of the maximum preheating temperature.

17. A method of using a joining element in a heat-superimposed mechanical joining process, the method comprising:
providing a joining element having a coating, the coating providing a high thermal stability and an optimized friction coefficient; and
driving the joining element into at least two stacked components after at least one of the components has been preheated at a joining location.

18. A self-piercing joining element for use in a joining method, wherein at least one of at least two components to be joined is preheated, the self-piercing joining element comprising:
a body configured to be deformed during a joining process, the body being at least partially coated with a thermally-stable coating.

19. The self-piercing joining element of claim 18, wherein the coating includes a base coating which has a high thermal stability, and a friction control coating which is applied on the base coating.
